(19) United States
(12) Patent Application Publication
(10) Pub. No.: US 2008/0285822 A1
(43) Pub. Date: Nov. 20, 2008

(54) Automated Stool Removal Method For Medical Imaging

(75) Inventors: Michael Kaus, Toronto (CA); Rafael Wiemker, Kisdorf (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/091,753

(22) PCT Filed: Oct. 17, 2006
(86) PCT No.: PCT/IB2006/053823

§ 371 Date: Apr. 28, 2008

Related U.S. Application Data
(60) Provisional application No. 60/597,087, filed on Nov. 9, 2005.

(51) Int. Cl. G06K 9/00

(52) U.S. Cl. 382/128

(57) ABSTRACT

A registration process that allows for assessment of deformation in the gastrointestinal region is provided. The registration process includes a classification process that classifies image data into the type of material imaged. The registration process further includes an automated segmentation process that allows for identification of the materials in the imaging region and allows for removal of objects, such as stool, from imaging data to allow for registration of images.

The present invention relates to radiotherapy and in particular to radiotherapy in regions of the gastrointestinal tract.

Radiotherapy is the treatment of diseases, such as cancer tumors, with radiation, such as X-ray radiation. In the course of administering radiation to the diseased tissue, some healthy tissue is also exposed to the radiation. Exposure of healthy tissue to radiation can cause treatment related complications. As such, it is desirable to accurately and precisely conform the dose to the diseased region so that the radiation is applied predominately to the diseased tissue and minimally to the surrounding healthy tissue.

An accurate and precise contour of the treated region (the planning target volume or PTV) incorporates the motion of the target during fractionated treatment. Motion can be physical movement of the patient with respect to the setup of the patient at the time of treatment planning (setup error), or movement, deformation, growth or shrinkage of the internal tissues, including the diseased tissue, caused by physiological functions, such as cardiac, respiratory, and digestive systems, or as a result of treatment response. A prominent example is the change due to peristalsis, e.g. changing stool and bowel gas through the organs of interest.

Current practice uses standard error margins from patient statistics to derive PTVs. These are not patient specific and often wasteful as to dose application to normal tissue. Acquiring several datasets prior or throughout the course of fractionated radiotherapy treatment has the potential to quantitatively assess patient-specific motion and effects of treatment on the patient. In order to quantitatively analyze these datasets, it is necessary to relate all datasets to the coordinate system of the initial image datasets by resolving both rigid transformations and differences due to deformable geometry. Algorithms that accommodate geometric differences between image datasets are called image registration.

The presence of stool or similar objects is particularly troublesome for such techniques because not only does stool and bowel move through the system, thereby moving or displacing organs and tissue, but also it is not consistently present in all image datasets with regards to size, shape or location. Patient immobilization techniques to reduce motion in the GI area exist, but are unpleasant to the patient and rarely used.

Current image registration methods are generally not acceptable to accurately define deformations in such treated region. Registration methods based on similarity in gray values assume one-to-one correspondence between image pairs; in other words, the images cannot include values that are only present in one image, such as the case when stool is present in the imaging area. In addition, change in grey value is often interpreted as deformation, which is not necessarily true if e.g. an air pocket in the rectum is replaced with stool. These effects will cause grey-value techniques to fail since the differences between the template and the deformed target image will not converge to a correct solution. Surface-based registration methods infer volumetric deformations based on given surface deformations. These methods potentially circumvent the problems of volumetric grey-value based methods. However, surface-based techniques require identification of the surfaces of the structures, which in some areas, such as the rectum and prostate, is difficult to automate since CT imagery does not include sufficient surface features. Consequently, the contours must be determined manually.

As such, it is desirable to provide an automated method that removes stool from the imaging region thereby allowing grey-value based registration of the treated region without manual contouring.

The present invention is directed to an improved registration method for medical imaging. In some embodiments, the improved registration method is used to automatically remove stool or bowel gas from the imaging data to allow for more precise registration of image data.

In some embodiments, a registration method includes a classification process, an automated segmentation process and a registration process. The registration method can be used to remove stool or other objects from the image data.

In the accompanying drawings, which are incorporated in and constitute a part of this specification, embodiments of the invention are illustrated, which, together with a general description of the invention given above, and the detailed description given below serve to illustrate the principles of this invention. One skilled in the art should realize that these illustrative embodiments are not meant to limit the invention, but merely provide examples incorporating the principles of the invention.

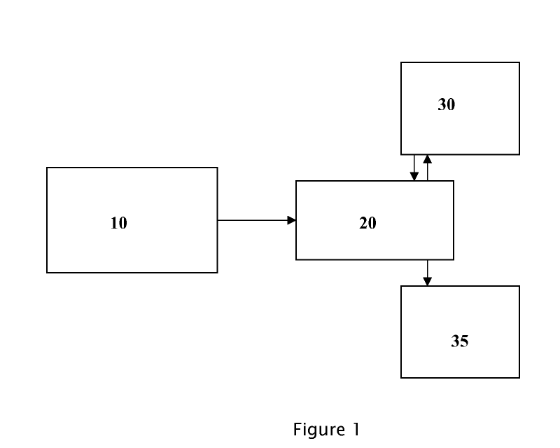

FIG. 1 illustrates an example of an imaging system that can be used to implement the registration processes disclosed herein.

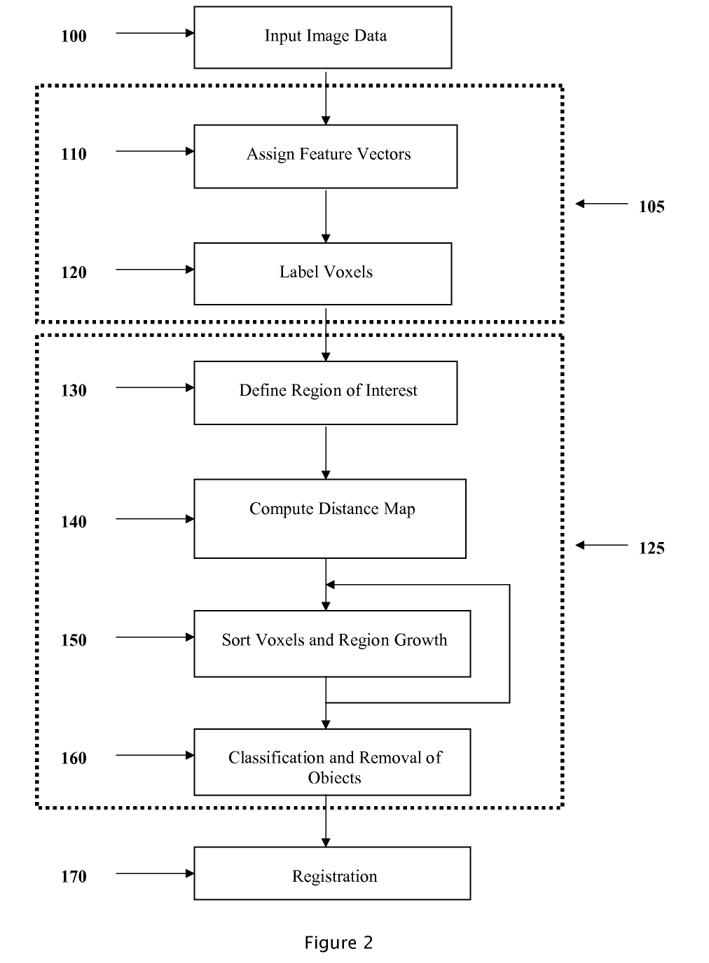

FIG. 2 illustrates an example of a registration method.

The registration method and algorithm disclosed herein provides an automated procedure in which stool is removed from the imaging region thereby allowing accurate registration of image pairs with different levels of bowel and stool content. By removing stool, bowel, and other similar objects from the image, quantitative deformation fields between image pairs can be estimated, dose distributions can be transformed into the coordinate system and geometry of the planning image, potentially allowing accumulating and adapting dose in changing patient geometries. These tools have the potential to increase the precision of prescribed doses allow, thus increasing tumor control and minimizing the dose to surrounding healthy tissue.

In one embodiment of the invention, the stool is removed from both CT images by using a modified grey-value technique. In such embodiments, results from segmentation and classification allow the replacement of the grey values of image voxels belonging to stool with soft-tissue grey values, thereby enabling the use of a global weighted grey-value similarity measure with deformable image registration. This and other methods will be become apparent to one skilled in the art from a reading of this description including the specific embodiments described herein. One skilled in the art will appreciate that the embodiments described herein are merely illustrative of the inventive concept and consequently are not meant to limit the scope of the invention beyond that which has been claimed.

FIG. 1 illustrates the general structural framework for implementing the various embodiments of the registration method disclosed herein. An imaging apparatus 10, such as a CT, MRI ultrasound, or other anatomical imaging modality, acquires image data. It should be appreciated that the imaging data can be collected at the same time and/or same location as the registration of the images, or alternatively the data can be collected at a different time and/or location. The imaging data is transferred to a processing unit 20. User interface 30 allows the user to receive information from the processing unit 20 and input information to the processing unit 20. The information, including the reconstructed images, can be displayed on display unit 35.

FIG. 2 illustrates an exemplary embodiment of the present invention. At 100, image data acquired from the imaging apparatus 10 is input into the processing unit 20 and the registration algorithm is commenced. First, at 105, the image voxels are classified into major classes, namely organ tissue, other tissue, air, bone and stool. This is done by assigning a feature vector to each voxel at 110. Each feature vector is a 1×18 vector comprising the concatenation of i) the row-major-order 1D vector derived from the 2D 3×3 square window of grey values, and ii) the 2D 3×3 square of gradient values. At 120 each voxel is then labeled according to major class. This can be done using any classification scheme, such as, for example, k-means or k-NN. Accordingly, each voxel is labeled as either organ tissue, other tissue, air, bone, or stool. Each voxel is also assigned a probability vector describing the probability with which it belongs to a particular major class.

At 125 the segmentation processes commences. Generally at 130 the region of interest is first identified. Although not required, the limitation of the segmentation process to the region of interest allows for faster processing time since areas outside of the region of interest need not be segmented. At 140, a distance map is computed. In order to generate the distance map, a binary image, wherein all voxels of soft tissue and stool are labeled as “1” and all of voxels are labeled as “0” is formed. The major classification of the voxels enables such a binary image to be created. The binary image is then subject to a distance transform, such as that described in G. Borgefors, “Distance Transformations in Digital Images,” Computer Vision, Graphics and Image Processing 34, 344-371, 1986, which is hereby incorporated by reference. For each “in” voxel, which was labeled as “1” in the binary image, the distance transform computes the distance to the nearest “out” voxel, which was labeled as “0” in the binary image. In addition, for each voxel within the region of interest, the maximum Laplacian axis value (MLAV) is calculated. The Laplacian axis measures the blob-likeliness of a structure by looking at the neighborhood to see how fast the distance values drop. For example, if the distances drop off on all directions at relatively the same rate, the object is spherical. The more negative the MLAV, the more blob-like the object is.

At 150 the voxels are sorted according to ascending MLAV and the voxel with the most negative MLAV is used for the first seed growth for the three-dimensional region growing. The region growing starts at the seed point and grows in the direction of the highest distance value. Since the objects are assumed to be spherical, the object grows equally in all directions. Growth of the object is stopped when the distance values drop sharply. After completion of the growing process for that object, the object is assigned a D/O value, which is equal to the ratio of the sum of the distances at the surface to the surface area. The surface area is estimated from (V/(4*pi/3))̂(1/3), since the object was assumed to be spherical. The seed growing processes is described in further detail in International Patent Publication No. WO2004/088589A1 entitled Volume Measurements in 3D Datasets, published Oct. 14, 2004 and hereby incorporated by reference.

After the growth of the first region, the registration processes loops back to determine if there is another seed point. The next most negative MLAV voxel is used, after all points within the previous growth region(s) have been eliminated. The region growth continues until there are no additional seed points.

At 160 the growth regions are classified into groups based on their D/O ratio using k-means. Growth regions that have a D/O ratio larger than a predetermined threshold value are classified as stool. Growth regions that have a D/O ratio smaller than the threshold value are classified as tissue. Once the stool has been properly classified it can be removed from the image data. The process can then move to the registration processes, wherein any registration algorithm can be used.

Upon review of this disclosure, one skilled in the art should appreciate that the illustrative method disclosed herein accommodates the geometric changes of a region of interest via a deformable registration algorithm relaying on grey value similarity measurements from a pre-processed image. Such a registration has several uses, including resolution of geometric differences in order to do dose accumulation and adaptive replanning in-spite of deforming organs. In addition, contours to secondary datasets can be automatically provided based on their registration to a first dataset.

The invention has been described with reference to one or more preferred embodiments. Clearly, modifications and alterations will occur to other upon a reading and understanding of this specification. It is intended to include all such modifications, combinations, and alterations insofar as they come within the scope of the appended claims or equivalents thereof.

1. An image registration method comprising:
inputting image data to be registered;
classifying the image data into tissue classes;
automatically segmenting the image data in order to remove one or more tissue classes; and
registering the segmented image data.

2. The image registration method of claim 1 wherein the tissue class removed comprises stool or bowel gas.

3. The image registration method of claim 1 wherein classifying the image data into tissue classes comprises:
assigning a feature vector to each voxel; and
labeling the voxels according to tissue class.

4. The image registration method of claim 1 wherein the tissue classes are selected from organ tissue, other tissue, air, bone and stool.

5. The imaging registration method of claim 1 wherein the automatic segmentation is performed only a selected region of interest.

6. The image registration method of claim 1 wherein automatically segmenting the image data in order to remove one or more tissue classes comprises:
creating a binary image;
computing a distance map on the binary image;
computing the maximum Laplacian axis value for each voxel;
sorting the voxels based on maximum Laplacian axis value; and
growing regions from seed points selected based on voxel maximum Laplacian axis value.

7. The image registration method of claim 6 further comprising calculating the D/O ratio for each growth region.

8. The image registration method of claim 7 further comprising classifying each growth region into one of two classes.

9. The image registration method of claim 8, wherein a first class comprises growth regions above a threshold D/O ratio, wherein said first class comprises stool or bowel gas.

10. An apparatus for registering images comprising:
a means for inputting image data to be registered;
a means for classifying the image data into tissue classes;
a means for automatically segmenting the image data in order to remove one or more tissue classes; and
a means for registering the segmented image data.

11. The apparatus of claim 10 wherein the tissue class removed comprises stool or bowel gas.

12. The apparatus of claim 10 wherein the means for classifying the image data into tissue classes comprises:
a means for assigning a feature vector to each voxel; and
a means for labeling the voxels according to tissue class.

13. The apparatus of claim 10 wherein the means for automatically segmenting the image data in order to remove one or more tissue classes comprises:
means for creating a binary image;
means for computing a distance map on the binary image;
means for computing the maximum Laplacian axis value for each voxel;
means for sorting the voxels based on maximum Laplacian axis value; and
means for growing regions from seed points selected based on voxel maximum Laplacian axis value.

14. The apparatus of claim 13 further comprising means for calculating the D/O ratio for each growth region.

15. The apparatus of claim 14 further comprising means for classifying each growth region into one of two classes.

16. The apparatus of claim 15, wherein a first class comprises growth regions above a threshold D/O ratio, wherein said first class comprises stool or bowel gas.

17. A radiation therapy method comprising:
obtaining medical image data from two different time periods;
inputting image data into a system processor;
classifying the image data into tissue classes;
automatically segmenting the image data in order to remove one or more tissue classes; and
registering the segmented image data.

18. The radiation therapy method of claim 17 wherein the tissue class removed comprises stool or bowel gas.

19. The radiation therapy method of claim 17 wherein classifying the image data into tissue classes comprises:
assigning a feature vector to each voxel; and
labeling the voxels according to tissue class, and
wherein automatically segmenting the image data in order to remove one or more tissue classes comprises:
creating a binary image;
computing a distance map on the binary image;
computing the maximum Laplacian axis value for each voxel;
sorting the voxels based on maximum Laplacian axis value; and
growing regions from seed points selected based on voxel maximum Laplacian axis value.

20. The radiation therapy method of claim 19 further comprising:
calculating the D/O ratio for each growth region; and
classifying each growth region into one of two classes,
wherein a first class comprises growth regions above a threshold D/O ratio, wherein said first class comprises stool or bowel gas.

21. A method of registering images of the gastrointestinal region comprising:
inputting image data to be registered;
classifying the image data into tissue classes, including one class comprising stool;
removing the stool from the image data; and
registering the image data from which the stool has been removed.
